(19) United States
(12) Patent Application Publication
(10) Pub. No.: US 2026/0369020 A1
(43) Pub. Date: Nov. 19, 2026

(54) Method and device for processing and interpretation of images in the electromagnetic spectrum

(71) Applicant: George STANTCHEV, Phoenix, AZ (US)

(72) Inventors: George STANTCHEV, Phoenix, AZ (US); Ivaylo STOYANOV, Kazanlak (BG)

(73) Assignee: George STANTCHEV, Phoenix, AZ (US)

(21) Appl. No.: 19/132,379

(22) PCT Filed: Nov. 25, 2022
(86) PCT No.: PCT/US2022/051002

§ 371 Date: May 23, 2025

(51) Int. Cl. G06V 10/143; G01N 21/35; G06V 10/147; G06V 10/25; H04N 23/11; H04N 23/13

(52) U.S. Cl. CPC G06V 10/143; G01N 21/35; G06V 10/147; G06V 10/25; H04N 23/11; H04N 23/13; G01N 2201/127

(57) ABSTRACT

This invention relates to a device for processing and interpretation of images in the electromagnetic spectrum, which will find application in the field of broad-spectrum thermography for spectral imaging analysis for remote object recognition. The created device includes a first CMOS sensor (1) connected to a graphics processor (3) and a second CMOS thermal head (2) connected to an interface converter (4). The graphics processor (3) and the interface converter (4) are connected to a microprocessor (5), which in turn is connected to a second interface converter (6) connected to a video display (7). The microprocessor (5) is also connected to a peripheral microprocessor (10), which is connected to a compass (8), to an accelerometer (9), to a remote control module (11), to a control unit (12) and to an interface connector for connection with external devices (13).

### TECHNICAL FIELD

This invention relates to a method and device for processing and interpretation of images in the broad electromagnetic spectrum, in the ultraviolet, light and infrared range, and will find application for the identification of the chemical content of substances and in particular for the inspection of buildings, for fire prevention, for production and quality control and others. This invention also relates to the use of spectral imaging of emitted and received light spectra for non-invasive and remote detection of the presence, location, and/or amount of a selected target substance by spectral imaging.

### BACKGROUND OF THE INVENTION

Spectral analysis is a branch of spectroscopy and photography in which at least one spectral information is collected from an image plane (e.g., a two-dimensional image) for an object in a particular scene. The image capture device may be pointing at a scene to capture image information for that scene. Various methods for spectral imaging are known. Examples include hyperspectral imaging, multispectral imaging, full spectral imaging, imaging spectroscopy, chemical imaging, and the like. Historically, hyperspectral imaging and multispectral imaging have been associated with satellite, aerial, or large-scale operations using large, expensive camera systems that are not suitable for manual work or everyday business, as well as for consumer applications.

Spectral analysis typically involves capturing spectral information from one or more portions of the electromagnetic spectrum. Although spectral information can be used for each wavelength in the electromagnetic spectrum, spectroscopy often uses spectral information for wavelengths in the range of about 100 nm to about 14,000 nm. The range of the electromagnetic spectrum is divided into the following ranges: ultraviolet band (UV) from 100 to 400 nm; visible band (VIS) from 400 to 700 nm; near infrared range (NIR) from 700 to 1500 nm; shortwave infrared range (SWIR) from 1500 to 3000 nm; medium wave infrared range (MWIR) from 3000 to 5000 nm; and a long-wavelength infrared (LWIR) range of 5000 to 14000 nm. The ultraviolet band includes the following subbands: far ultraviolet band (FUV) from 122 to 200 nm; middle ultraviolet band (MUV) from 200 to 300 nm; and near ultraviolet band (NUV) from 300 to 400 nm. The ultraviolet band is also divided into the following subbands: ultraviolet C tape (UVC) from 100 to 280 nm; ultraviolet B band (UVB) from 280 to 315 nm; and ultraviolet A tape (UVA) from 315 to 400 nm.

Infrared thermography is a method of visualizing an object by interpreting the infrared rays it emits compared to an absolutely black body. The higher the temperature of the object, the greater the radiation from it. The need to see in complete darkness or in reduced visibility-smoke or fog, provokes the development and implementation of technologies with the ability to interpret rays of a wide electromagnetic spectrum in many industries. The thermal image is a transformation of the thermal signature of an observed object, i.e. its infrared energy produced by a scene in the 8 pm to 14 pm band in digital data. This data can be used to create a visible image or to enter on a computer for interpretation or post-processing. By converting heat radiation into an electrical signal, infrared cameras create an image that is visible to the human eye. Because the heat energy of a scene is independent of the reflected light and because it can move through objects with small particle sizes, heat treatment is a technology that is suitable for receiving images in all conditions where the light is limited or missing.

Spectral information captured for a scene can be represented as superimposed images that form a three-dimensional array. In spectroscopy, an array of data is obtained when the spectrally resolved image is represented in a three-dimensional volume in which the captured image is represented by a plurality of two-dimensional images, while the spectral information associated with individual pixels or groups of pixels is represented as the third coordinate in the array of data.

Conventional broad-spectrum imaging is a powerful but expensive analysis technology for remotely determining the chemical composition of a surface. For example, a broad-spectrum spectral image typically generates an array of data with two spatial dimensions and one spectral dimension, for which two-dimensional images are taken at 100 to 400 frames per second, and the 3rd dimension has about 256 frames for spectral analysis, typically formed from one camera through many filters. These frames must be processed in real time, which requires extremely fast and expensive electronics.

### SUMMARY OF THE INVENTION

The object of the invention is to provide a method and device for processing and interpretation of images in the wide electromagnetic spectrum, which provide spectral image analysis for non-invasive and remote recognition of objects, regardless of the environment and light intensity, as well as to identify chemical content of substances and checking for the presence of organic matter.

The problem is solved by creating a device for processing and interpretation of images in the wide electromagnetic spectrum, which includes a first CMOS sensor connected to a graphics processor and a thermal head with a second CMOS sensor in the thermal range connected to an interface converter. The graphics processor and the interface converter are connected to a microprocessor, which in turn is connected to a second interface converter connected to a video display. The microprocessor is also connected to a peripheral microprocessor, which in turn is connected to a compass, an accelerometer, a remote control module, a control unit, and an interface connector for connection to external devices. The microprocessor, on the other hand, is also connected to a USB connector, an SD card connector, a WiFi module, a Bluetooth module, and a GPS module.

A third CMOS sensor in the spectral range of the short and medium infrared SWIR is connected to the microprocessor via the interface connector for connection to external devices.

An external luminaire is connected to the interface connector for connection to external devices to calibrate the CMOS sensor according to the captured scene.

The external luminaire has a changing spectral range in the range from 0.2 nm to 12 nm, during the recording of spectral pictures.

The problem is solved by creating a method for processing and interpretation of images in the electromagnetic spectrum for application on the created device, the method includes the following operations:
calibration of the CMOS sensor and the second CMOS sensor in the thermal head for each spectral range;
scanning the full spectrum of all sensors and recording all spectral pictures; analysis of the spectral characteristics and their normalization for each pixel or zone;
compilation of a complex spectral picture for each scene.

Additionally, the method includes the operations:
creating a reference picture of a scene for each emitter;
analysis of the reference picture;
recognition of the target element from the reference picture.

The created device visualizes a complex picture based on correlation between spectral pictures from all ranges; calculates the correlation between the zones in the spectral images to obtain a digital spectral picture at the corresponding wavelength; records spectral images using the frequency characteristics of the pixel or the zones of the CMOS sensor itself; calculates and visualizes complex numbers for each zone or pixel; and uses standardized optics to provide uniform angular recognition for each pixel or area.

The advantage of the created device is that it provides high picture quality and image detail in the recognition of still or moving objects, regardless of the environment, from intense light to complete darkness. In addition, the chemical content of the substances is recognized using broad spectrum chromatography. An advantage is the ability to connect the created device with a portable meteorological device, which provides information about wind speed, humidity, altitude, temperature and others, as a result of which the location of the observed object can be adjusted.

### BRIEF DESCRIPTION OF DRAWINGS

This invention is illustrated in the accompanying figures, where

FIG. 1 is a schematic diagram of a device for processing and interpretation of images in the electromagnetic spectrum according to the invention;

FIG. 2 shows a two-dimensional matrix of a spectral image with plotted recognition zones;

FIG. 3 shows a layered three-dimensional matrix of the same image with layered areas of all spectral ranges;

FIG. 4 shows a scene irradiated with different wavelengths and captured with a thermal camera;

FIG. 5 shows exemplary material recognition using differential and conditional correlation between two images;

FIG. 6 shows a diagram of a CMOS sensor for day and night vision where scanning is performed based on frequency correlation;

FIG. 7 shows recognition of materials at the pixel or band level by broad spectrum spectrography and capture of 22 frames with different wavelengths; and

FIG. 8 shows a diagram of the detection method.

### DETAILED DESCRIPTION OF THE INVENTION

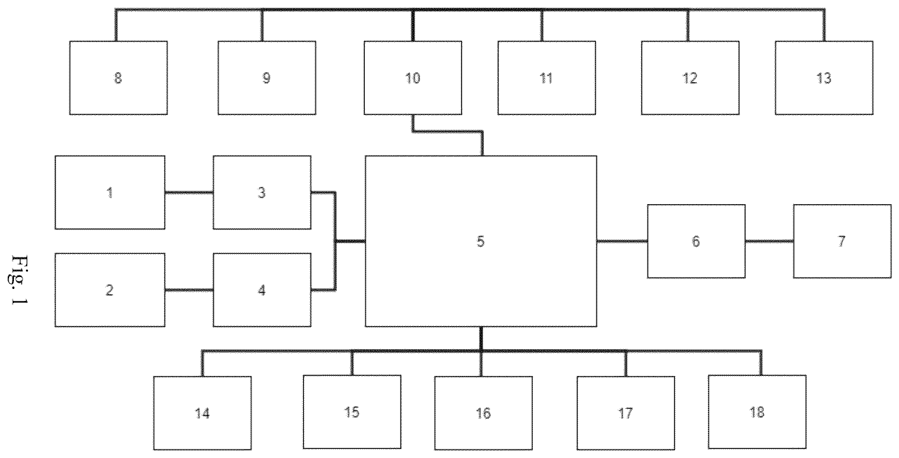

The created device for processing and interpretation of images in the electromagnetic spectrum, shown in FIG. 1, includes a CMOS sensor 1 connected to a graphics processor 3 and a thermal head 2 with a second CMOS sensor in the thermal range connected to an interface converter 4. The graphics processor 3 and the interface converter 4 are connected to a microprocessor 5, which in turn is connected to a second interface converter 6 connected to a video display 7. The microprocessor 5 is also connected to peripheral microprocessor 10, which in turn is connected to compass 8, accelerometer 9, remote control module 11, control unit 12 and interface connector for connection to external devices 13. The microprocessor 5 on the other hand is also connected to USB connector 14, SD card connector 15, WiFi module 16, Bluetooth module 17 and GPS module 18.

A third CMOS sensor in the spectral range of the short and medium infrared SWIR is connected to the microprocessor 5 via the interface connector for connection to external devices 13.

An external luminaire is connected to the interface connector for connection to external devices 13 to calibrate the CMOS sensor 1 according to the captured scene.

The external luminaire has a changing spectral range in the range from 0.2 nm to 12 nm, during the recording of spectral pictures. The CMOS sensor 1 is a type of semiconductor image sensor, representing a 13 megapixel matrix, which converts the beams of photons falling on its surface into an electrical signal in digital form. This digital signal, via the MIPI interface (Mobile Industry Processor Interface) is transmitted to the graphics processor 3 for processing and changing its parameters in order to extract a quality image. In the graphics processor 3 the image resolution, the data transmission frequency, as well as the contrast, brightness, gamma correction, saturation, sharpness and other parameters of the picture are determined. After performing the necessary processing, the digital data is fed to the microprocessor 5, specialized in the processing of digital video signals.

Simultaneously, the thermal head 2 measures the power of electromagnetic radiation in the same scene observed by the CMOS sensor 1, taking into account the heating of the materials with a certain variable electrical resistance, depending on the temperature. Through a specialized processor and a second CMOS thermal sensor built into the thermal head 2, the measured power of electromagnetic radiation is visualized. Like any digital image, thermal images are composed of pixels, each of which represents a specific temperature value. Images are usually interpreted in grey scale, where dark areas show lower temperatures and light areas warmer. Each point in the captured temperature range can be interpreted with a unique colour or hue based on its temperature value.

However, before an image is extracted, it is necessary to correct the inhomogeneous data obtained from the different pixels. This calibration is realized both in production conditions with reference to a reference body, and subsequently in real time, accompanying the operation of the device. After performing the calibration, some of the pixels do not behave as expected and generate anomalous values. By means of linear interpolation, realized in the specialized processor of the thermal head 2, high resolution of the signal is achieved without data loss.

After processing the data from the thermal head 2, the finished image is fed for conversion to the interface converter 4. The interface converter 4 serves to convert the signal from RGB (Red Green Blue) to MIPI format suitable for the digital video input of the microprocessor 5. By means of a suitable mixing at the pixel level the data from the CMOS sensor 1 and the sensor in the thermal head 2 are superimposed on each other, thus achieving an image containing the detail of the data about the observed object both in the visible spectrum and its temperature characteristics and changes. The integrated overlay (combining different layers of data) in the output image of the microprocessor 5 allows visualization of text and graphics on the image obtained from the thermal head 2 and the CMOS sensor 1. The second interface converter 6 converts the MGRI format of the output image of the microprocessor 5 to the LVDS format (Low-voltage differential signalling), suitable for visualizing on the display 7.

The compass 8 and the accelerometer 9 provide information about the geographical coordinates, the position in which the device is directed, its orientation, the angle at which it is directed and changes in acceleration, if any.

The interface connector for connection to external devices 13 is a UART connector (Universal asynchronous receiver-transmitter), which allows for updating the software of the device, as well as for adding external modules such as rangefinder, external power supply and others.

The created device for processing and interpretation of images in the electromagnetic spectrum combines the data from the compass 8, the accelerometer 9 and other external devices connected via the interface connector for connection to external devices 13, and these data are collected and processed by the peripheral microprocessor 10. After being processed, the data is sent, by means of a serial protocol, to the microprocessor 5, where it is superimposed in the form of text and graphics on the already mixed thermally and visible images.

The user interface implemented in the graphics layer of the microprocessor 5 gives access to settings of the video processing modules of the CMOS sensor 1, the graphics processor 3, the sensor of the thermal head 2 and the display 7, as well as the compass 8, the accelerometer 9 and the remote control module 11. Through the user interface of the microprocessor 5 settings are made to the USB connector 14, the SD card connector 15, the WiFi module 16, the Bluetooth module 17 and the GPS module 18. Depending on the application of the device, the implemented user interface allows different configurations.

By means of the Wi-Fi module 16, the wireless video signal can be transmitted in real time to various devices that support this functionality. The microprocessor 5 implements video recording software, both in the internal memory of the device and in external memory accessible through the SD card connector 15. The recording visualizes both the information collected by the CMOS sensor 1 and the sensor of the thermal head 2, and also an overlay added to the graphics layer of the microprocessor 5 of the device. The recordings are available to the user via the USB connector 14 for connection to a computer, or for direct viewing on the display 7 of the device.

The Bluetooth module 17 establishes a connection with a telephone, with a special application that allows two-way communication between the telephone and the device. The device sends real-time values from all its sensors. In turn, the phone sends GPS coordinates to the device, as well as commands that allow remote handling of the user interface through the remote control module 11, which also shows the orientation of the device on a map.

To obtain an accurate idea of the position of the observed object in certain applications, a portable weather station can be connected to the device via the Bluetooth module 17. Based on parameters such as humidity, temperature, altitude, wind speed and direction, ballistic calculation functions have been implemented, and data from a rangefinder attached to the device can also be used. Through the created interface and the use of a compass and automatic distance measurement, the exact position of the recognized material is determined.

The created device allows the observation of absorption spectra of compounds, which are a unique reflection of their molecular structure, allowing their identification. The photon energies associated with this part of the infrared flux (1 to 15 kcal/mol) are not large enough to excite electrons, but they can cause vibrational excitation of covalently bonded atoms and groups. Molecules experience a wide variety of vibrational movements characteristic of their atoms. Therefore, almost all organic compounds will absorb infrared radiation, which corresponds to the energy of these vibrations.

The device uses the information from the daily and thermal picture of an object, obtained in completely independent ways, to reproduce and interpret various characteristics of this object, visible in the waveband between 0.25 pm to 12 pm. Through appropriate mixing and digital processing, the best recognition of objects is performed, regardless of the environment-from intense light to complete darkness. Based on infrared chromatography, the device recognizes the chemical contents of the observed object, identifies the materials from which it is made, as well as the presence of organic matter.

The variety of interfaces implemented in the device allows easy reconfiguration, addition of additional sensors that capture different bands of the electromagnetic spectrum, external peripherals depending on the specific requirements for monitoring and detection of certain objects. The design and coupling with a specially designed optical part allows the development of interferometers with application in materials science and industrial quality control, in the inspection of buildings, in fire safety, in agriculture and others.

The first used broad-spectrum CMOS sensor 1 covers 3 light ranges: ultraviolet 0.15 to 0.45 pm, light 0.45 to 0.95 pm and infrared 0.95 to 1.5 pm. The second used CMOS thermal sensor covers the average infrared range of 1.5 to 5 pm. A third CMOS thermal sensor covering the far infrared range from 5 to 12 pm was also used.

Each of these sensors is connected to a configuration of lenses that provide the same angular resolution for each pixel. To ensure uniform two-dimensional images of the scene, the same scanning angle (FOV) must be provided, so the optical parameters must be chosen appropriately, such as a 13-megapixel CMOS sensor with a resolution of 4208×3120, a pixel size of 1.1 microns and an objective having a lens with focal length 22 mm, field of view is 12×9 degrees and resolution 0.17 minutes.

To ensure the same analysis area for the thermal CMOS sensor with a resolution of 320×256, a pixel size of 12 microns, a an objective having a lens with a focal length of 18 mm must be used; then the resolution will be 2.3 minutes.

To change the sensitivity of the CMOS sensor 1 to the light in the near infrared region, the pixels are combined into larger arrays-binning. For example, to achieve the same resolution of the first sensor as the thermal one, the pixels of the first sensor are combined into an array of 16 x16 pixels. Thanks to the binning, the first sensor can operate with a sensitivity proportional to the pixel size of 1.1, 2.2, 4.4, 8.8 and 17.6 microns and a corresponding resolution of 0.17, 0.34, 0.69, 1.38 and 2.75 minutes while maintaining the same area and viewing angle. Captured 2D images are based on minimal information bits, the minimum size of which is the pixel size, but may be larger and combine multiple pixels, which determines the resolution of the recognition.

Additionally, to ensure a quality spectral picture, it is necessary to calibrate all sensors in the spectral ranges in which they operate. To perform this calibration, normalized light sources in the respective spectral bands, ultraviolet, light green, red, blue, ultraviolet with near, medium and far wavelength, are used. A uniform scene irradiated with the corresponding spectral band is used for calibration.

When detecting an image, it is possible to use a similar light source if a greater enhancement of the detection effect is to be obtained. Under such irradiation, the light source in each spectrum is absorbed and reflected with different intensity, which changes the data for each pixel along the spectral axis, which in the corresponding analysis depict the characteristics of the materials in the scene to be analysed.

This invention can be used to detect any type of target substance having spectral characteristics that can be viewed in at least parts of the visual fields of the spectral array of the image. Individual pixels or groups of pixels from captured image information can be analysed to assess whether the pixels show spectral characteristics of the target substance. In embodiments that use high-resolution image capture elements, this allows even minutes of traces of a target substance to be detected if even a single pixel in the image corresponds to the target substance. Moreover, by recognizing which pixel(s) of the captured image information corresponds to the target substance, the exact location of the target substance in the image can be located and identified.

The recognition of the substances itself takes place by forming a matrix of values for each pixel, scanned at different modes of the used sensors. These modes are mainly dependent on the spectral band in which the scene is shot. When these values are analysed in the mode of frequency, quantitative and qualitative evaluation, the independence characteristic of the chemical evaluation of the material is obtained.

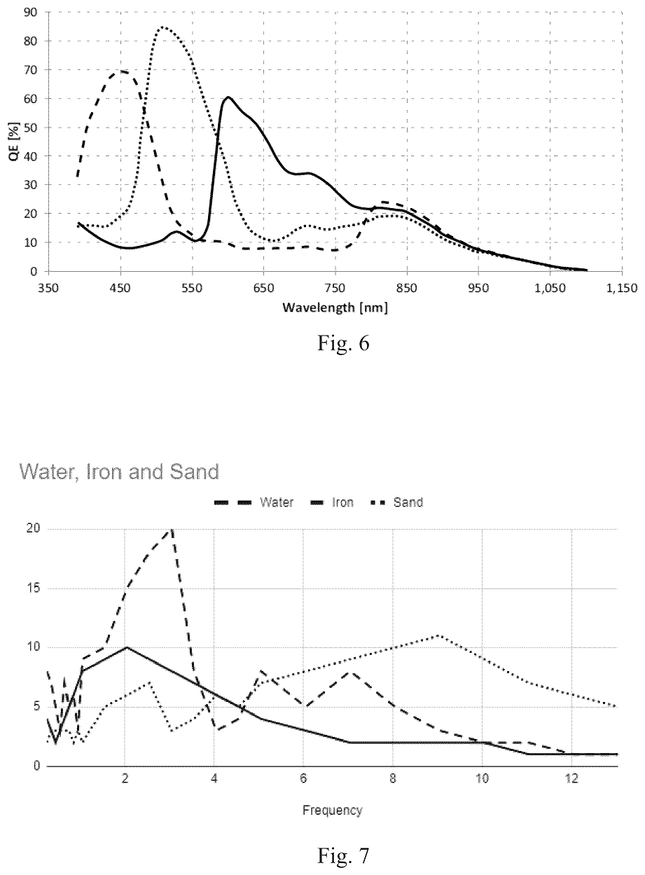

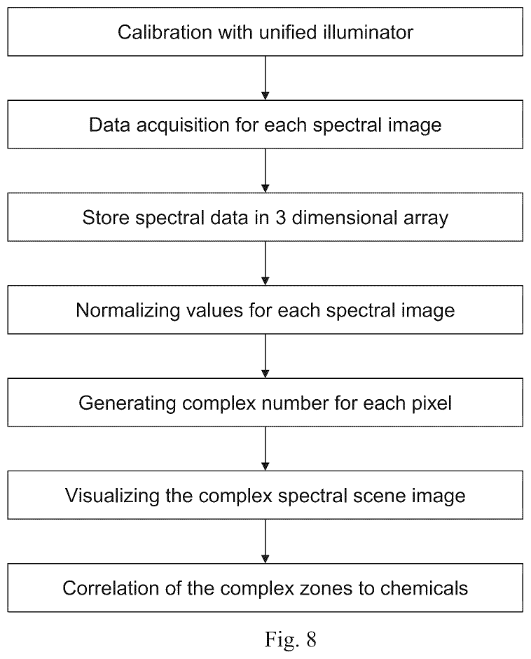

To determine the sensitivity of the first CMOS sensor 1, its ability to receive 3 independent images with wavelengths of 450 nm, 550 nm and 650 nm is used. Similar selectivity can be deduced for 350 nm, 750 nm, 850 nm and 950 nm for most of these sensors. An example of a sensor characteristic for such recognition is shown in FIG. 6, where images captured at each frequency are analysed through correlation.

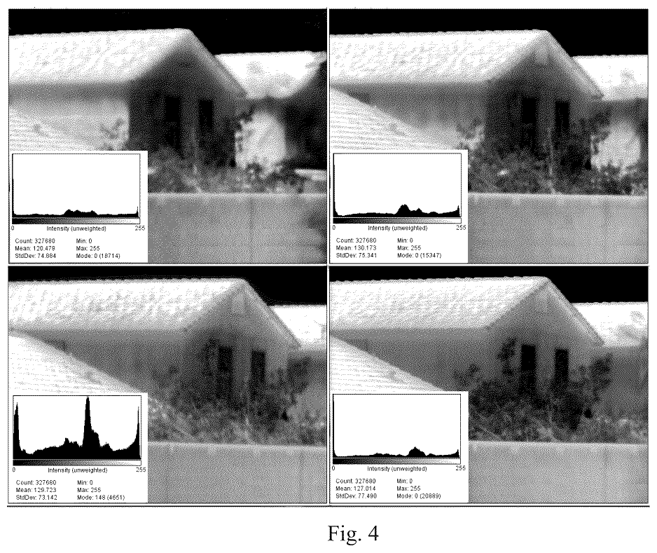

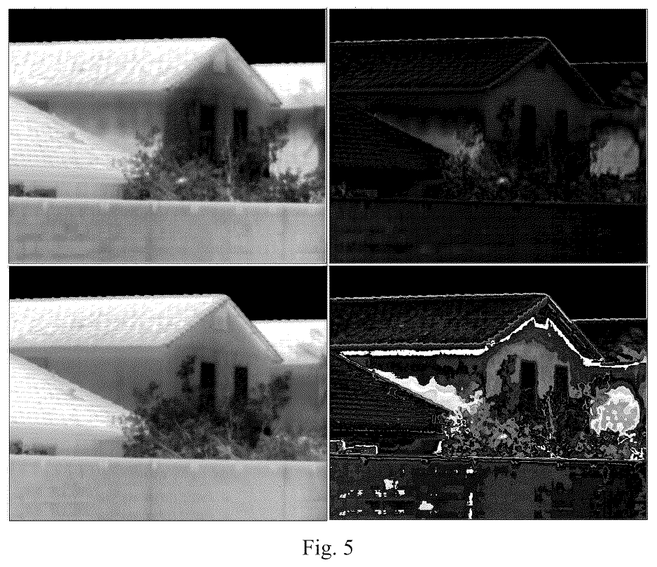

In order for each spectral band to be identified and isolated with the highest precision in the thermal range for each signal arriving from a wide-spectrum sensor, a special calibration mode is required. This calibration is performed on the basis of the following 2 conditions: an emitter is used in the respective band and the image received by the sensor is analysed by a sensitivity histogram with and without the reference light from the emitter. In this way, the sensitivity of the respective detector is determined by the respective wavelength. An example is shown in FIG. 4, where 4 methods of irradiation with rays of 5, 7, 9 and 12 micrometres, respectively, are used. The emitter may not be emitting continuously and may produce flashes that are synchronized with the frame. The most effective way to analyse is if the flash is every second frame of a progressive frame image so as to identify 2 pictures between which to find the difference. Such a detection method is shown in FIG. 5 where the pictures with and without irradiation are correlated with each other by a difference filter and an XOR filter. In this way, the areas of interest are identified and visualized instantly.

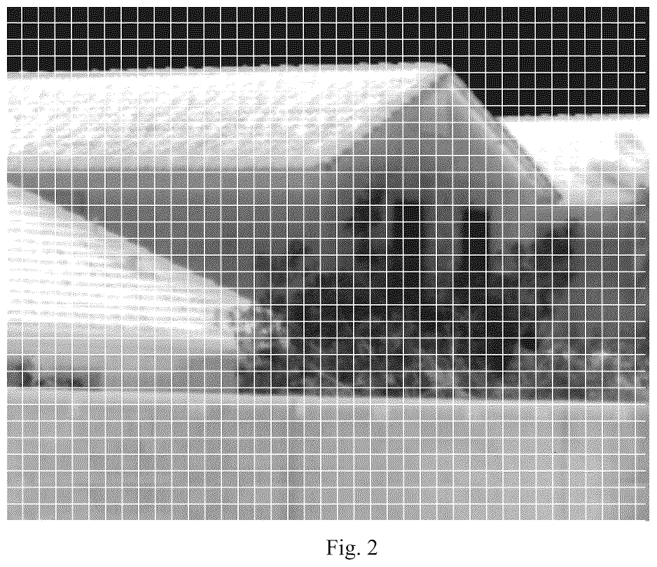

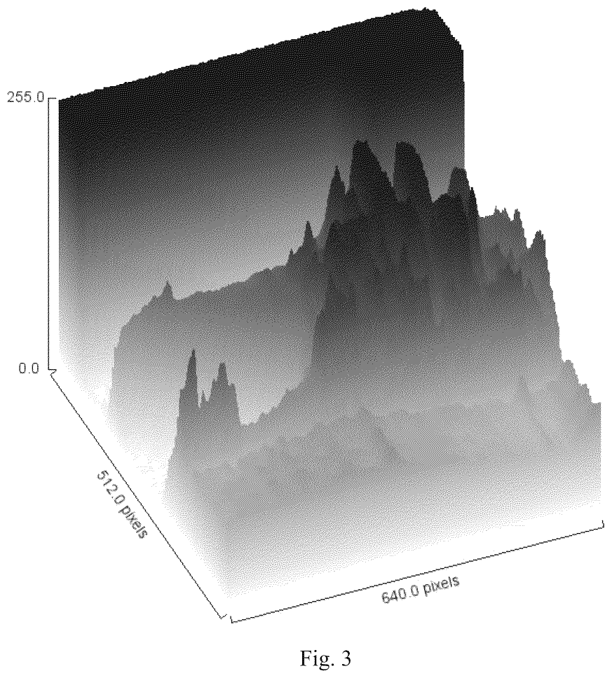

The completeness of the method for determining target substances is achieved when the specific values are taken from the scanned wavelengths, normalized to the value 1 or another selected value and presented in numerical order for each pixel or area of the image. An exemplary division of the two-dimensional picture into zones is shown in FIG. 2. The normalized values of each zone or normalized pixel, as explained above when calculating the angular area of observation, are superimposed in a series as shown in FIG. 7 or are represented as a complex number and are represented as a 3 dimensional array as shown in FIG. 3.

FIG. 3 shows a three-dimensional image of the spectral model where each zone or in this case each pixel is depicted vertically with its respective value normalized to 255 or 8 bit resolution. This resolution can be 16, 32, 48, etc. depending on the complexity of the target recognition.

The advantage of the created device is that it provides recognition of substances with standard sensor matrix and without the need to use external filters, special frequency-dependent sensors requiring special pixel geometry, which makes many recognition devices more expensive. For this purpose, the frequency-dependent image is created by analytical transformation and correlation between an array of spectral images and in particular by analysing the relationship between the change of a pixel or a zone.

Detection of material by NIR and LWIR spectrography is aided by emission consisting of a wavelength capable of absorbing the target compound. The materials are detected by the full electromagnetic spectrum from 100 nm to about 14,000 nm using a set of two chambers, NIR and LWIR, while the SWIR range was extrapolated.

The created device for processing and interpretation of images in the electromagnetic spectrum is used by the following method.

The sensors are calibrated from the electronic interface described above for each range, using a reference scene and a possible external luminaire if necessary. The sensors are then programmed to receive in the appropriate wavelength by direct reading, mode change, correlation, binning or the use of a digital filter. The corresponding images are also recorded for each operating spectral range and a three-dimensional array is created in which each zone or pixel has a value depending on the frequency/spectral picture. These values are normalized to the dynamic range of the sensors.

The values for each pixel are formed by arranging the normalized values from each spectral picture of the scene sequentially, forming a complex number. This complex number of all zones is visualized in a complex picture that shows the complex characteristics of the scene. The various compounds are correlated to this complex number for each pixel or zone.

The recognized elements are identified by an overlay and coloured in zones and are displayed on the current spectral picture, whether it is video or thermal. In this way, the desired chemical element is imposed on the basis of the picture that is depicted at the time.

1. A device for processing and interpretation of images in the electromagnetic spectrum, wherein it comprises a first CMOS sensor (1) connected to a graphics processor (3) and a thermal head (2) with a second CMOS sensor in the thermal range, connected to interface converter (4), the graphics processor (3) and the interface converter (4) being connected to a microprocessor (5), which in turn is connected to a second interface converter (6) connected to a video display (7), wherein the microprocessor (5) is also connected to a peripheral microprocessor (10), which in turn is connected to a compass (8), an accelerometer (9), a remote control module (11), a control unit (12) and an interface connector for connection to external devices (13), the microprocessor (5) on the other hand being connected to a USB connector (14), an SD card connector (15), a Wi-Fi module (16), a Bluetooth module (17) and GPS module (18).

2. The device according to claim 1, wherein third CMOS sensor in the spectral range of the short and medium infrared SWIR or MWIR is connected to the microprocessor (5) via the interface connector for connection to external devices (13).

3. The device according to claim 1, wherein external luminaire for calibrating the CMOS sensor (1) is connected to the interface connector for connection to external devices (13) according to the captured scene.

4. The device according to claim 3, wherein external luminaire has a changing spectral range from 0.2 um to 12 um, during the recording of the spectral pictures.

5. A method for processing and interpreting images in the electromagnetic spectrum, for application of the device of claim 1, wherein it comprises the following operations:
calibration of the CMOS sensor (1) and the CMOS sensor in the thermal head (2) for each spectral range;
scanning the full spectrum of all sensors and recording all spectral pictures;
analysis of the spectral characteristics and their normalization for each pixel or zone;
compilation of a complex spectral picture for each scene;-depiction of the complex spectral picture and correlation of the zones of interest to target substances.

6. The method according to claim 5, wherein scene reference picture is created for each emitter.

7. The method according to claim 5, wherein an analysis of the reference picture is performed.

8. 7. The method according to claim 6, wherein an analysis of the reference picture is performed.

9. The method according to claims 5 wherein the recognition of the target element from the reference picture is performed.

10. The method according to claim 6, wherein the recognition of the target element from the reference picture is performed.

11. The method according to claim 7, wherein the recognition of the target element from the reference picture is performed.
